(19) United States
(12) Patent Application Publication
(10) Pub. No.: US 2006/0001654 A1
(43) Pub. Date: Jan. 5, 2006

(54) Apparatus and method for performing data entry with light based touch screen displays

(75) Inventor: Gerard Dirk Smits, Los Gatos, CA (US)

Correspondence Address: BEYER WEAVER & THOMAS LLP, P.O. BOX 70250, OAKLAND, CA, 94612-0250, US

(73) Assignee: National Semiconductor Corporation, Santa Clara, CA (US)

(21) Appl. No.: 10/923,567

(22) Filed: Aug. 20, 2004

Related U.S. Application Data
(60) Provisional application No. 60/584,776, filed on Jun. 30, 2004.

(51) Int. Cl. G09G 5/00

(52) U.S. Cl. 345/176

(57) ABSTRACT

An apparatus and method for performing data entry with light based touch screen displays and that is capable of implementing the functions of inking, pressure sensitive data entries, the rate of descent and angle of entry of the pen or stylus, the ability to rotate objects, double-clicking objects, fast clicking, etc. The apparatus and method includes a touch screen and a stylus having a tip that compresses depending on the amount of force is applied to the stylus when placed in contact with the touch screen during a data entry operation. A processor is provided to generate a display on the touch screen that traces the movements of the stylus on the touch screen. To implement the inking function, the processor is configured to extrapolate the relative thickness of the display generated on the touch screen to be commensurate with the amount of compression of the tip caused by the amount of writing force applied to the stylus. The amount of compression of the tip also enables pressure sensitive data entries.

### CROSS REFERENCE TO RELATED APPLICATIONS

This patent application claims the benefit of Provisional Patent Application Ser. No. 60/584,776, filed Jun. 30, 2004, which is incorporated herein by reference for all purposes.

### BACKGROUND OF THE INVENTION

1. Field of the Invention

The present invention relates generally light based to touch screen displays, and more particularly, to an apparatus and method for performing data entry with light based touch screen displays.

2. Description of the Related Art

User input devices for data processing systems can take many forms. Two types of relevance are touch screens and pen-based screens. With either a touch screen or a pen-based screen, a user may input data by touching the display screen with either a finger or an input device such as a stylus or pen.

One conventional approach to providing a touch or pen-based input system is to overlay a resistive or capacitive film over the display screen. This approach has a number of problems. Foremost, the film causes the display to appear dim and obscures viewing of the underlying display. To compensate, the intensity of the display screen is often increased. However, in the case of most portable devices, such as cell phones, personal digital assistants, and laptop computers, high intensity screens are usually not provided. If they were available, the added intensity would require additional power, reducing the life of the battery of the device. The films are also easily damaged. These films are therefore not ideal for use with pen or stylus input devices. The motion of the pen or stylus may damage or tear the thin film. This is particularly true in situations where the user is writing with a significant amount of force. In addition, the cost of the film scales dramatically with the size of the screen. With large screens, the cost is therefore typically prohibitive. Ambient light creates another problem with film type input screens. The ambient light may cause glare on the screen making it harder to read. The ambient light may also increase noise, making data inputs more difficult to detect.

Another approach to providing touch or pen-based input systems is to use an array of source Light Emitting Diodes (LEDs) along two adjacent X-Y sides of an input display and a reciprocal array of corresponding photodiodes along the opposite two adjacent X-Y sides of the input display. Each LED generates a light beam directed to the reciprocal photodiode. When the user touches the display, with either a finger or pen, the interruptions in the light beams are detected by the corresponding X and Y photodiodes on the opposite side of the display. The data input is thus determined by calculating the coordinates of the interruptions as detected by the X and Y photodiodes. This type of data input display, however, also has a number of problems. A large number of LEDs and photodiodes are required for a typical data input display. The position of the LEDs and the reciprocal photodiodes also need to be aligned. The relatively large number of LEDs and photodiodes, and the need for precise alignment, make such displays complex, expensive, and difficult to manufacture.

Yet another approach involves the use of polymer waveguides to both generate and receive beams of light from a single light source to a single array detector. These systems tend to be complicated and expensive and require alignment between the transmit and receive waveguides and the lenses and the waveguides. The waveguides are usually made using a lithographic process that can be expensive or difficult to source. See for example U.S. Pat. No. 5,914,709.

Writing with an instrument such as a pen or felt tip marker on paper, the thickness or boldness of the lines is largely determined by the amount of pressure exerted on the writing instrument. For example, if a significant amount of pressure is used, thick, bold lines result. Alternatively, thin, faint lines result if a minimal amount of pressure is used. The process of accurately portraying lines of the proper thickness and boldness depending on the amount of pressure exerted on a touch screen display by a stylus or pen is called “inking”. Similar to writing with a pen on paper, thick, bold lines should appear on the screen when a relatively large amount of writing pressure is used. Thin, faint lines should appear when a relatively small amount of writing pressure is used.

Current input devices used with touch displays, such as a pen or a stylus, have limited functionality. For one, they usually can not implement the inking function as described above, unless they have been design with some pressure sensitive abilities. Furthermore, they typically have limited ability to perform functions normally associated with a mouse. Known pens or stylus can be used to select icons, open pull down menus, or for writing. It is believed, however, that such pens or stylus usually can not be used to implement more advanced input functions, such as pressure sensitive data entries, the ability to rotate objects, double-clicking, fast clicking or other force and/or rate of detection functions, or detect the angle or rate of descent of the stylus or pen.

Accordingly, there is a need for an apparatus and method for apparatus and method for performing data entry with light based touch screen displays and that is capable of implementing the functions of inking, pressure sensitive data entries, the ability to rotate objects, double-clicking objects, fast clicking, etc.

### SUMMARY OF THE INVENTION

The present invention relates to an apparatus and method for performing data entry with light based touch screen displays and that is capable of implementing the functions of inking, pressure sensitive data entries, the rate of descent and angle of entry of the pen or stylus, the ability to rotate objects, double-clicking objects, fast clicking, etc. The apparatus and method includes a touch screen and a stylus having a tip that compresses depending on the amount of force is applied to the stylus when placed in contact with the touch screen during a data entry operation. A processor is provided to generate a display on the touch screen that traces the movements of the stylus on the touch screen. To implement the inking function, the processor is configured to extrapolate the relative thickness of the display generated on the touch screen to be commensurate with the amount of compression of the tip caused by the amount of writing force applied to the stylus. The amount of compression of the tip also enables pressure sensitive data entries.

### BRIEF DESCRIPTION OF THE DRAWINGS

The invention, together with further advantages thereof, may best be understood by reference to the following description taken in conjunction with the accompanying drawings in which:

FIG. 1 is a touch screen display device according to one embodiment of the invention.

FIG. 2 is a perspective view of a stylus or pen according to the present invention.

FIG. 3a-3d is a close up view of the stylus or pen used during operation.

FIGS. 4a-4d are width profiles as measured by the touch screen display corresponding to FIGS. 3A-3D respectively.

FIG. 5 is a flow diagram illustrating the sequence of operation for implementing the inking function of the present invention.

FIG. 6 is another touch screen display device according to another embodiment of the present invention.

FIG. 7 is a flow diagram illustrating calculation for the speed of descent of a stylus contacting the touch screen display according to the present invention.

FIGS. 8a-8e are a series of interrupt shadows illustrating various angles of descent using an input stylus according to the present invention.

In the figures, like reference numbers refer to like components and elements.

### DETAILED DESCRIPTION OF THE INVENTION

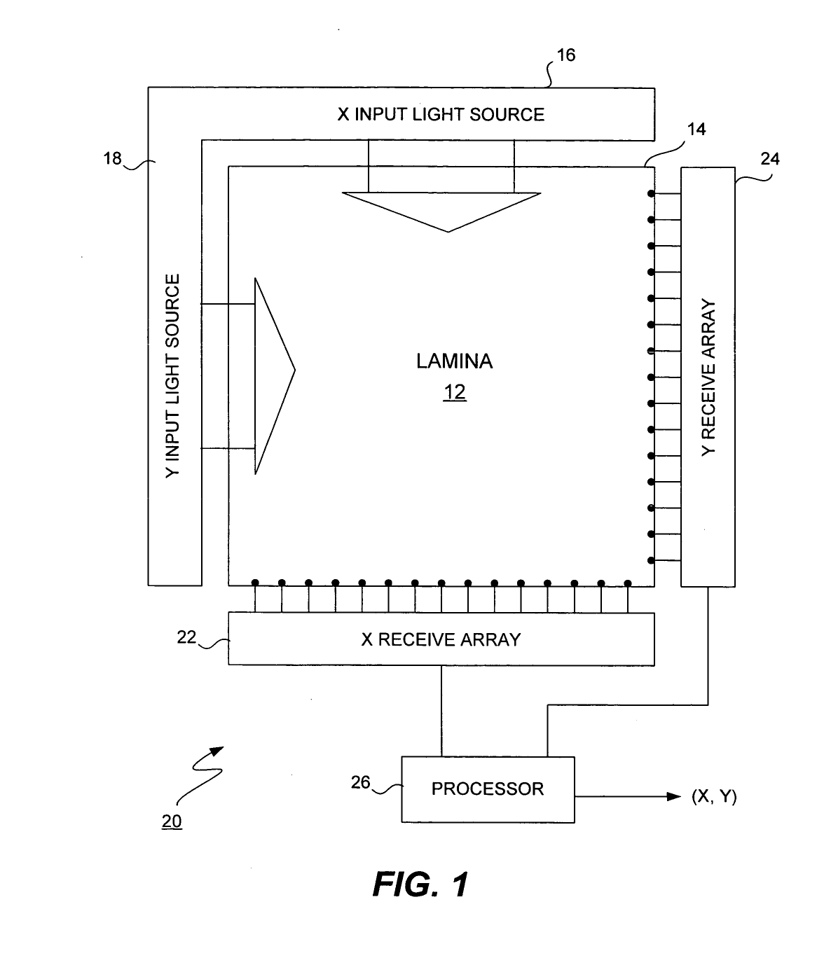

Referring to FIG. 1, a touch screen data input device according to one embodiment of the invention is shown. The data input device 10 defines a continuous sheet or “lamina” 12 of light in the free space adjacent to a touch screen 14. The lamina 12 of light is created by X and Y input light sources 16 and 18 respectively. An optical position detection device 20, optically coupled to the lamina of light, is provided to detect data entries to the input device by determining the location of interrupts in the lamina caused when data is entered to the input device. The optical position detection device 20 includes an X receive array 22, a Y receive array 24, and a processor 26. During operation, a user makes a data entry to the device 10 by touching the screen 14 using an input device, such as a pen or stylus. During the act of touching the screen with the pen or stylus, the lamina 12 of light in the free space adjacent the screen is interrupted. The X receive array 22 and Y receive array 24 of the optical position detection device 20 detect the X and Y coordinates of the interrupt. Based on the coordinates, the processor 26 determines the data entry to the device 10. For more information on the data entry device 10, see co-pending, U.S. application Ser. No. 10/817,564, entitled Apparatus and Method for a Data Input Device Using a Light Lamina Screen and an Optical Position Digitizer, filed Apr. 1, 2004, and incorporated by reference herein for all purposes.

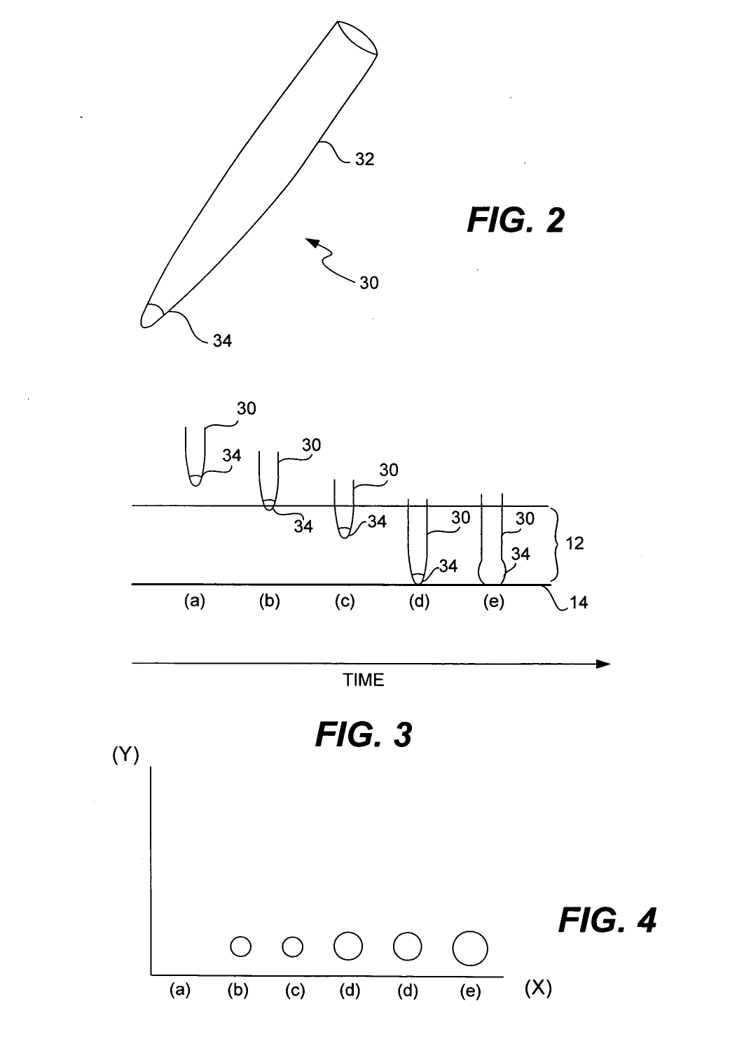

Referring to FIG. 2, a perspective view of a stylus according to the present invention is shown. The stylus 30 includes two parts, an elongated handle 32 and a deformable tip 34, located at the writing end of the stylus. During use, the operator holds or grips the stylus 30 using the handle 32. The deformable tip 34 of the stylus 30 is then placed in contact with the touch screen 14 of the data input device 10. When the tip 34 contacts the surface of the touch screen 14, it deforms by compressing. The greater the downward pressure the user places on the stylus 30, the wider the compression of the deformable tip 34. The X receive array 22 and Y receive array 24 of the optical position detection device 20 detect not only the X and Y coordinates of the interrupt, but also the width of the interrupt. Based on the detected width, the processor 26 is then able to extrapolate the proper thickness of the lines to be drawn on the display 14. When a large amount of pressure is applied, the tip 34 compresses and thick, bold lines are created on the touch screen 14. When little pressure is applied, the amount of compression is minimal, resulting in thin, faint lines being created on the touch screen 14. In one embodiment, the deformable tip is substantially round in shape and has a radius of approximately 1 mm and the thickness or lamina of light 12 is approximately 0.6 mm high. It should be noted that these dimensions are merely illustrative and in now way should be construed as limiting the present invention.

FIG. 3 is a series of enlarged cross-section views of the stylus during a write operation. The figure shows the lamina 12 over the surface of the touch screen display 14. The figure also shows, in a series of sequential “time shots” (a) through (e), the position of the stylus 30 during a write operation. Initially, as designated by the letter (a), the stylus 30 is above the lamina 12 adjacent the surface of the touch screen display 14. The tip 34 is in its normal, non-compressed state, at this point. At the time designated by the letters (b) and (c), the tip 34 of the stylus has broken the plane defined by the lamina 12 above the surface of the touch screen 14. The tip 34 remains in its non-compressed state. At the time designated by the letter (d), the tip 34 of the stylus 30 has just contacted the surface of the touch screen 14. Since a writing force is not being exerted at this instant of time, the tip 34 has not yet compressed. Finally, as illustrated at the time designated by the letter (e), a large amount of writing force is applied to the stylus 30. The additional force causes the tip 34 to significantly compress. In this case, the processor 26 extrapolates that a significant amount of writing pressure is being exerted on the stylus 30, and therefore creates thick, bold lines on the touch screen 14.

Regardless if a large or small amount of writing force is applied, the processor 26 re-creates or traces the movement of the stylus 30 on the screen. For example, if the user writes the word “dog”, the letters “d”, “o” and “g” will appear on the touch screen display 14. The thickness or boldness of the letters is determined by the amount the tip 34 of the stylus 30 compresses. If a wide interrupt is detected as measured by the X receive array 22 and Y receive array 24, the processor 26 extrapolates that thick, bold lines should be created. If the interrupt is relatively narrow, thinner, faint lines are created.

In various embodiments of the invention, the dimensions of the stylus 30 and the tip 34 may vary. For example, the overall dimensions of the stylus 30 may resemble a standard writing instrument, such as a pen or pencil. The tip 34 of the stylus 30 can be made from any suitable compressible material, such as but not limited to, rubber, an elastic polymer, etc.

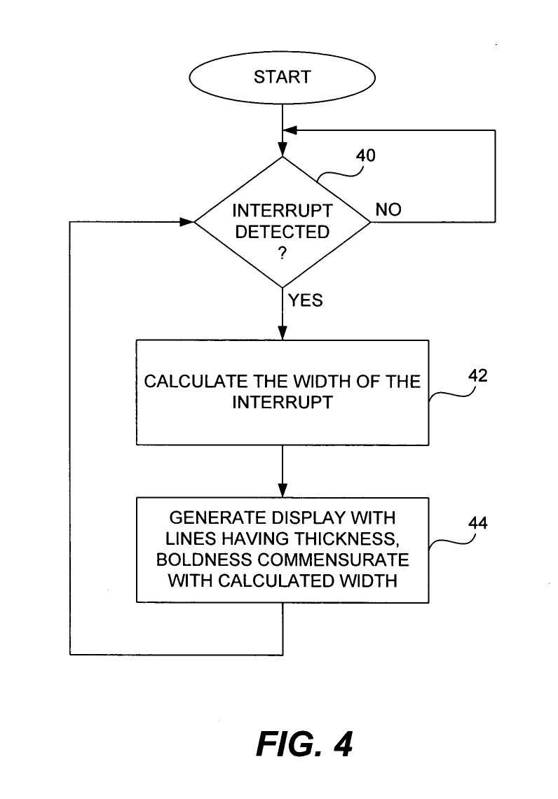

Referring to FIG. 4a-4d, width profiles as measured by the touch screen display corresponding to FIGS. 3a-3e respectively are shown. The profiles are measured by the X receive array 22 and Y receive array 24 of the optical position detection device 20. In FIG. 4a, no profile is detected because the stylus tip 34 has not yet broken the plane defined by the lamina 12. In FIGS. 4b and 4c, the stylus tip 34 just has broken the lamina 12. Since just the leading edge of the tip 34 has entered the lamina 12, the profile is relatively small. In FIG. 3d, the tip 34 of the stylus 30 has just contacted the surface of the touch screen 14. Since the tip 34 has not yet compressed, the profile is the same as 4a-4c. In FIG. 4e, the profile is larger due to the compression of the stylus tip 34.

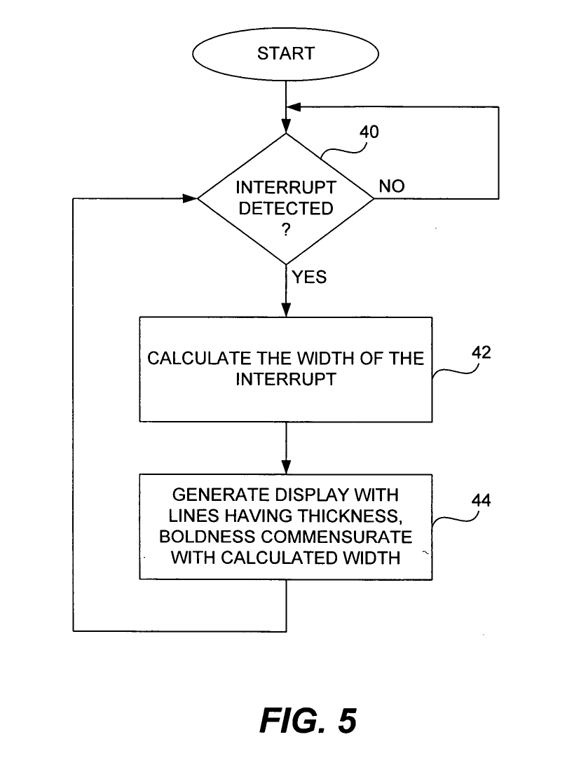

Referring to FIG. 5, a flow diagram illustrating the sequence of operation of the processor 34 in implementing the inking function of the present invention is shown. In the flow diagram 40, the processor 26 initially determines if an interrupt (i.e., the stylus 30 has broken the plane defined by the lamina 12) has occurred (decision diamond 40) If no, flow returns back to diamond 40, and the processor 26 again checks to see if an interrupt has occurred. This sequence of detecting for an interrupt is periodically repeated. Typically, the sample rate is sufficient such that there is no perceived delay between the time the stylus 30 breaks the plane defined by the lamina 12 and the appearance of the display on the screen 14. When an interrupt occurs, the processor 26 calculates the width of the interrupt (box 42). The processor 26 then generates on the touch screen a display that tracks the movements of the stylus 30 having line widths and a boldness commensurate with the calculated width of the tip 34 (box 44). Flow then returns to decision diamond 40. So long as an interrupt is detected, the processor 26 performs the sequence described in boxes 42 and 40. This results in the processor 26 creating a continuous display that tracks the movement of the stylus across the touch screen 14. When an interrupt is no longer detected, meaning the user has lifted the stylus 30 off the touch screen display 14, the processor 26 again begins to periodically sample for the next interrupt. When another interrupt is detected, the aforementioned process is repeated.

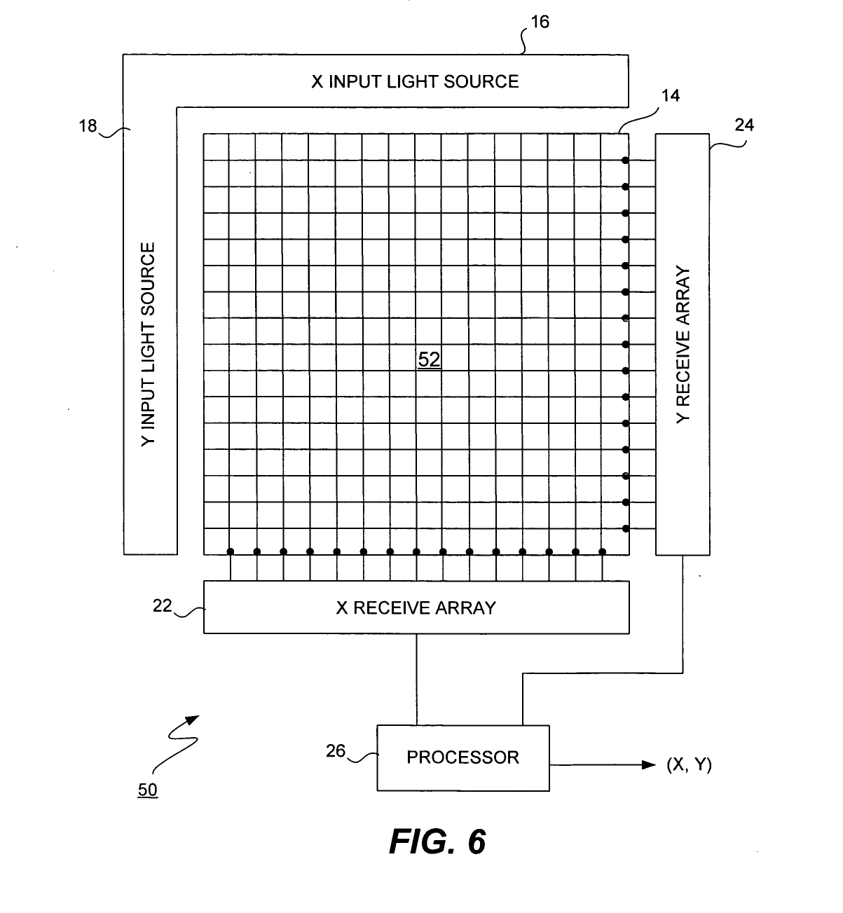

Referring to FIG. 6, another touch screen display device according to another embodiment of the present invention is shown. The data input device 50 defines a grid of light 52 in the free space adjacent to a touch screen 14. The grid of light 52 is created by an X and Y input light sources 16 and 18 respectively. An optical position detection device 20, optically coupled to the grid of light 52 of light, is provided to detect data entries to the input device by determining the location of interrupts in the grid of light 52 caused when data is entered to the input device. The optical position detection device 20 includes an X receive array 22, a Y receive array 24, and a processor 26. During operation, a user makes a data entry to the device 10 by touching the screen 14 using an input device, such as stylus 30. During the act of touching the screen with the stylus 30, the grid of light 52 in the free space adjacent the screen is interrupted. The X receive array 22 and Y receive array 24 of the optical position detection device 20 detect the X and Y coordinates of the interrupt. Based on the coordinates, the processor 26 determines the data entry to the device 10. For more information on X and Y input light sources 16 and 18 capable of generating the grid of light 12, see for example the waveguides described in U.S. Pat. No. 5,914,709, incorporated by reference herein.

The inking operation with a grid type display such as that illustrated in FIG. 5 is essentially the same as a lamina type display as described above. The processor 26 initially determines if an interrupt (i.e., the stylus 30) has broken the plane defined by the grid of light. When an interrupt occurs, the processor 26 determines the number of lines of the grid 52 that are broken, as sensed by the X receive array 22 and Y receive array 24. Based on the number of broken grid lines, the processor 26 calculates the width of the interrupt, and then generates a display with line widths and boldness commensurate with the calculated width. This sequence continuous for the duration of the interrupt. As a result, the processor 26 creates a continuous display that tracks the movement of the stylus across the touch screen 14. When an interrupt is no longer detected, meaning the user has lifted the stylus 30 off the touch screen 14, the processor 26 no longer generates the display. The aforementioned process is repeated when the next interrupt occurs.

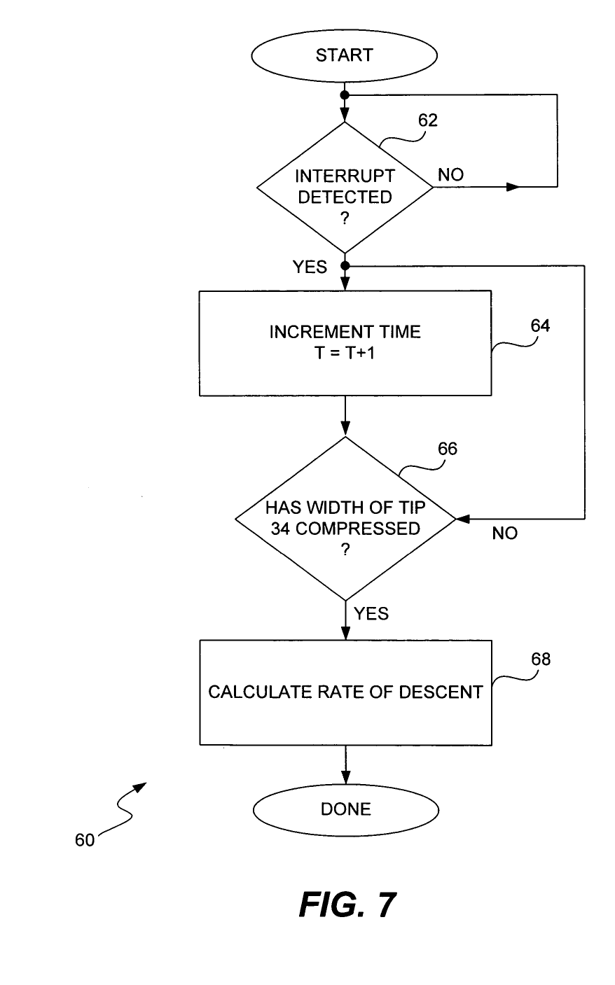

Referring to FIG. 7, a flow diagram 60 illustrating a sequence for calculating the rate of descent of a stylus 30 contacting the touch screen 14 according to the present invention is shown. The processor 26 initially determines if an interrupt (i.e., when the stylus 30 brakes the plane defined by the lamina 12 or grid 52) has occurred (decision diamond 62) If no, flow returns back to diamond 62, and the processor 26 again checks to see if an interrupt has occurred. This sequence of detecting for an interrupt is periodically repeated. When an interrupt occurs, the processor 26 sets the value of a time variable to T=0 (box 64). The processor 26 then checks at a known fixed time interval T if the width of the tip 34 has compressed (diamond 66). If not, the value of T is incremented (T=T+1). This cycle continues, with the value of T being incremented with each loop, until the tip 34 of the stylus compresses when in contact with the touch screen 14, as determined by processor 26. The final value of T is thus indicative of the duration of time between the stylus 30 breaking the lamina or grid of light and contacting the touch screen 14. When compression of the tip is detected, the processor 26 calculates the rate of descent (box 68). Specifically, the processor 26 calculates the rate by dividing the distance traveled by the stylus 30 (i.e., the known thickness or height of the light lamina 12 or grid 52) by the current value of T. The ability to detect the rate of descent and the amount of pressure exerted onto the touch screen 14 by the stylus 30 allows the stylus to be used as a more complex input device, for example fast clicking, slow clicking, slow-heavy clicking or fast-light clicking. These features are also helpful for handwriting recognition. For example, drawings, character recognition, object manipulation, all benefit from the enhanced detection of the natural motions, pressure and speeds of descent.

The ability to detect the amount of pressure being exerted on the stylus 30 provides the possibility of a number of features and benefits. As previously noted, the ability to detect the amount of pressure exerted on the stylus 30 is particularly useful for performing the inking function. The ability to detect pressure variations is also very useful for character recognition, for example with script letters or kanji characters. Pressure sensing may be used to increase the user's motor control with the stylus 30. Feedback pressure caused by the deformable tip 34 of the stylus 30 allows the user to correlate or feel a “sticky factor” before an object on the screen is selected or moved on the screen. The ability to detect pressure can also enable the stylus 30 to have mouse-like input functions. Different pressure responses can have different meanings. For example, an input below a first pressure threshold can be ignored as incidental. An input above the first, second and third thresholds, however, can each have different meanings respectively. Assertion of the stylus 30 at a pressure above the first threshold at the location of an icon on the display can be interpreted as an input request for a “pop-up” description of the icon. Assertion of the stylus 30 above a second pressure threshold can be construed as a single “mouse-click” input. Finally, assertion of the stylus 30 above a third pressure threshold can be construed as a “double-click” mouse input. It should be noted that the above-mentioned meanings of each pressure threshold are exemplary and in no way should be construed as limiting the invention.

The rate of descent and pressure could also be used to avoid unintentional clicks or deletes or other accidental data entries. For example, the system can be configured to allow a data entry when the stylus contacts the touch screen 14 within a range of a certain rate of descent, angle, or pressure. Any other contacts would be considered incidental and therefore would not register as a data input. This feature could be particularly useful with small hand-held devices, such as a personal digital assistant or cell phone, where accidental data entries commonly occur.

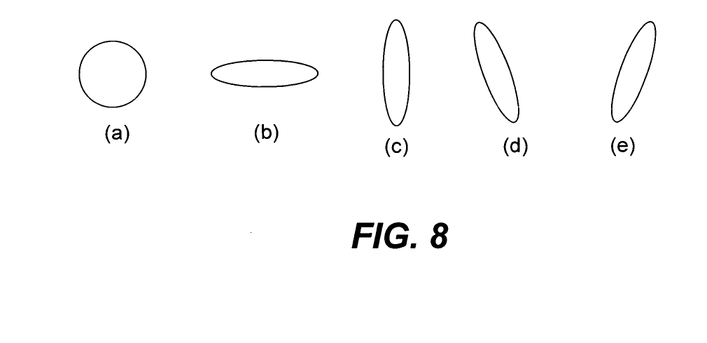

Referring to FIGS. 8a-8e, a series of interrupt shadows illustrating the angle of descent is shown. The interrupt shadows are measured by the X receive array 22 and Y receive array 24 of the optical position detection device 20. In FIG. 8a, the stylus 30 is placed perpendicular to the screen 14. The resulting interrupt is therefore the same as the diameter of the stylus 30. FIGS. 8b and 8c show the shadow interrupt sloped along the to the horizontal (x axis) and vertical (y axis) respectively. FIG. 8d shows the shadow interrupt typical of a right-handed person holding the stylus during a writing operation. FIG. 8e shows the shadow interrupt typical of a left-handed person holding the stylus during a writing operation. Holding the stylus at a slant in any direction results in an oblong shadow interrupt. Angle or orientation detection can be used to allow the user to rotate or otherwise manipulate objects on the screen 14.

The aforementioned light based data entry system can be used to uniquely detect and differentiate various forms of data touch entries. For example, it can differentiate data input devices (i.e., a pen, stylus, finger, brush or erasure) by the size of the interrupt. It can also be used to deduct force measurements from the distortion of a soft objects such as the deformable tip of a pen or stylus or a finger. It can be calibrated to learn various writing styles and then automatically recognize and respond appropriately. It also can be used to detect pressure applied to the data input device without actually measuring the exerted pressure on the input screen. Rather, pressure inputs are measure by the size of the deformation. Thus a soft writing instrument, such as a finger, felt tip pen, can be used to perform clicking and/or sliding (e.g., script writing) with little surface friction. In contrast, film type input systems typically require a sharp tip instrument to create the necessary pressure. The present invention is therefore more versatile. Finally, in one embodiment, the lamina 12 of light is approximately 0.5 to 1 mm adjacent the screen 14. So with a input instrument of 1 mm or greater, a shadow interrupt will be detected before contact with the touch screen 14.

In various embodiments of the invention, the processor 26 may be implemented in either hardware or software using either a microprocessor or microcontroller, a programmable logic device, an application specific integrated circuit, or any combination thereof. Accordingly, the inking function and the rate of descent functions described herein can be implemented in either hardware, software, or a combination thereof, depending on the design used to implement the processor 26.

Although the foregoing invention has been described in some detail for purposes of clarity of understanding, it will be apparent that certain changes and modifications may be practiced within the scope of the appended claims. Therefore, the described embodiments should be taken as illustrative and not restrictive, and the invention should not be limited to the details given herein but should be defined by the following claims and their full scope of equivalents.

We claim:

1. An apparatus, comprising;
a touch screen;
a stylus having a tip that compresses depending on the amount of force that is applied to the stylus, the stylus further configured to make data entries to the touch screen display by contacting the tip to the touch screen display; and
a processor configured to generate a display on the touch screen that traces the movements of the stylus on the touch screen, the processor further configured to extrapolate the relative thickness of the display generated on the touch screen to be commensurate with the amount of compression of the tip caused by the amount of force applied to the stylus.

2. The apparatus of claim 1, further comprising a lamina of light in the free space adjacent the touch screen.

3. The apparatus of claim 2, further comprising a light receive array positioned adjacent the lamina of light, the light receive array being configured to determine the location of an interrupt in the lamina of light when the stylus contacts the touch screen during a data entry operation.

4. The apparatus of claim 3, wherein the light receive array is further configured to detect the width of the interrupt caused by the compression of the tip of the stylus contacting the touch screen.

5. The apparatus of claim 2, wherein the light receive array further comprises a first light receive element to detect interrupts along a first axis and a second light receiving element to detect interrupts along a second axis.

6. The apparatus of claim 1, further comprising a grid of light in the free space adjacent the touch screen.

7. The apparatus of claim 6, further comprising a light receive array positioned adjacent the grid of light, the light receive array being configured to determine the location of an interrupt in the grid of light when the stylus contacts the touch screen during a data entry operation.

8. The apparatus of claim 7, wherein the light receive array is further configured to detect the width of the interrupt caused by the compression of the tip of the stylus contacting the touch screen.

9. The apparatus of claim 7, wherein the light receive array further comprises a first light receive element to detect interrupts along a first axis and a second light receiving element to detect interrupts along a second axis.

10. The apparatus of claim 1, wherein the tip of the stylus comprises but is not limited to one of the following: rubber or an elastic polymer.

11. The apparatus of claim 1, wherein the processor is implemented in one of the following: a microprocessor, a microcontroller, programmable logic, an application specific integrated circuit, or a combination thereof.

12. The apparatus of claim 1, wherein the processor is further configured to calculate the rate of descent of the stylus when the stylus is used to contact the touch screen during a data entry operation.

13. The apparatus of claim 1, wherein the processor is further configured to determine one of a plurality of different data inputs based on the amount of pressure exerted on the stylus exceeding a plurality of pressure thresholds respectively.

14. The apparatus of claim 14, wherein the plurality of different data inputs comprise one or more of the following:
an input request for a pop-up description of an icon;
a single mouse click input; or
a double-mouse click input.

15. The apparatus of claim 14, wherein the processor is further configured to calculate the angle of descent of the stylus when the stylus is used to contact the touch screen during a data entry operation.

16. A method, comprising:
performing an inking function for a touch screen display by
detecting an amount of compression of a deformable tip of a stylus contacting a touch screen during a data entry operation;
extrapolating the thickness of lines to be created on the touch screen based on the detected amount of compression of the deformable tip; and
displaying the lines of the extrapolated thickness on the touch screen.

17. The method of claim 16, wherein the detecting the amount of compression further comprises:
generating light in the free space adjacent the touch screen; and
detecting the width of the interrupt caused by the compression of the deformable tip when the writing stylus contacts the touch screen though the light.

18. The method of claim 17, wherein the displaying the lines further comprises generating relatively thick, bold lines when the amount of compression is relatively large and generating relatively thin, faint lines when the amount of compression is relatively small.

19. The method of claim 18, wherein the generating the light further comprising generating a lamina of light in the free space adjacent the touch screen.

20. The method of claim 19, wherein the generating the light further comprising generating a grid of light in the free space adjacent the touch screen.

21. The method of claim 16, further comprising calculating the rate of descent when the stylus is placed in contact with the touch screen during a write operation.

22. The method of claim 16, further determining one of a plurality of different data inputs based on the amount of pressure exerted on the stylus exceeding a plurality of pressure thresholds respectively.

23. The method of claim 22, wherein the plurality of different data inputs comprise one or more of the following:
an input request for a pop-up description of an icon;
a single mouse click input; or
a double-mouse click input.

24. The method of claim 16, further calculating the angle of descent of the stylus when the stylus is used to contact the touch screen during a data entry operation.
